(19) United States
(12) Patent Application Publication
(10) Pub. No.: US 2013/0000073 A1
(43) Pub. Date: Jan. 3, 2013

(54) PIPE SLEEVE

(76) Inventors: Rusmir Canic, Newport New, VA (US); Husnija Canic, Newport New, VA (US)

(21) Appl. No.: 13/175,265

(22) Filed: Jul. 1, 2011

(51) Int. Cl. F16L 5/02

(52) U.S. Cl. 16/2.2

(57) ABSTRACT

A pipe sleeve for housing a portion of a pipe that includes a body portion having a hollow interior and first and second end portions for receiving and housing the portion of the pipe therein; and a flexible gasket portion formed at the first end of the body portion opposite the second end receiving the portion of the pipe, wherein the flexible gasket portion extends into the hollow interior of the body portion at the first end thereof a predetermined distance and conforms to a size of the portion of the pipe and applies pressure thereto.

### BACKGROUND

The present invention relates to a pipe sleeve for various uses such as plumbing purposes.

Conventionally, a pipe sleeve is generally a protective element used to fill a gap between a pipe and another surface or as a covering to create a barrier between a pipe and its surroundings. Pipe sleeves are used during the construction of a building or pipe system. Pipe sleeves may be used to fill in the gaps where pipes may penetrate walls. This creates a barrier between the two sides through which air cannot pass. This type of sleeve may be made of many different materials such as polyvinyl chloride (PVC), sheet metal or of a fire-resistant type material. The pipe sleeve is often put on during construction to protect and/or insulate the pipe from the environment or vice versa.

There may be several problems associated with conventional pipe sleeves. For example, one problem is that a sealing component of the pipe sleeve may become easily separated from the body of the sleeve or not installed, thereby creating air or water leakage problems.

Therefore, it is desirable to provide pipe sleeve which provides sufficient support to accommodate the size of a pipe entering the pipe sleeve and which prevents the above-mentioned problems associated with conventional pipe sleeves.

### SUMMARY

According to one embodiment of the present invention, a pipe sleeve for housing a portion of a pipe is provided. The pipe sleeve includes a body portion having a hollow interior and first and second end portions for receiving and housing the portion of the pipe therein, and a flexible gasket portion (i.e., a boot) formed at the first end of the body portion opposite the second end receiving the portion of the pipe, wherein the flexible gasket portion extends into the hollow interior of the body portion at the first end thereof a predetermined distance, and conforms to a size of the portion of the pipe and applies pressure thereto.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a plan view of a pipe sleeve that can be implemented within embodiments of the present invention.

FIG. 2A and FIG. 2B are side and a front views, respectively, of a flexible gasket portion (i.e., a boot) of the pipe sleeve that can be implemented within embodiments of the present invention.

FIG. 3 is a plan view of a hollow interior of a body portion of the pipe sleeve shown in FIG. 1 that can be implemented within embodiments of the present invention.

FIG. 4 is a plan view of the pipe sleeve installed within a wall structure in accordance with embodiments of the present invention.

### DETAILED DESCRIPTION

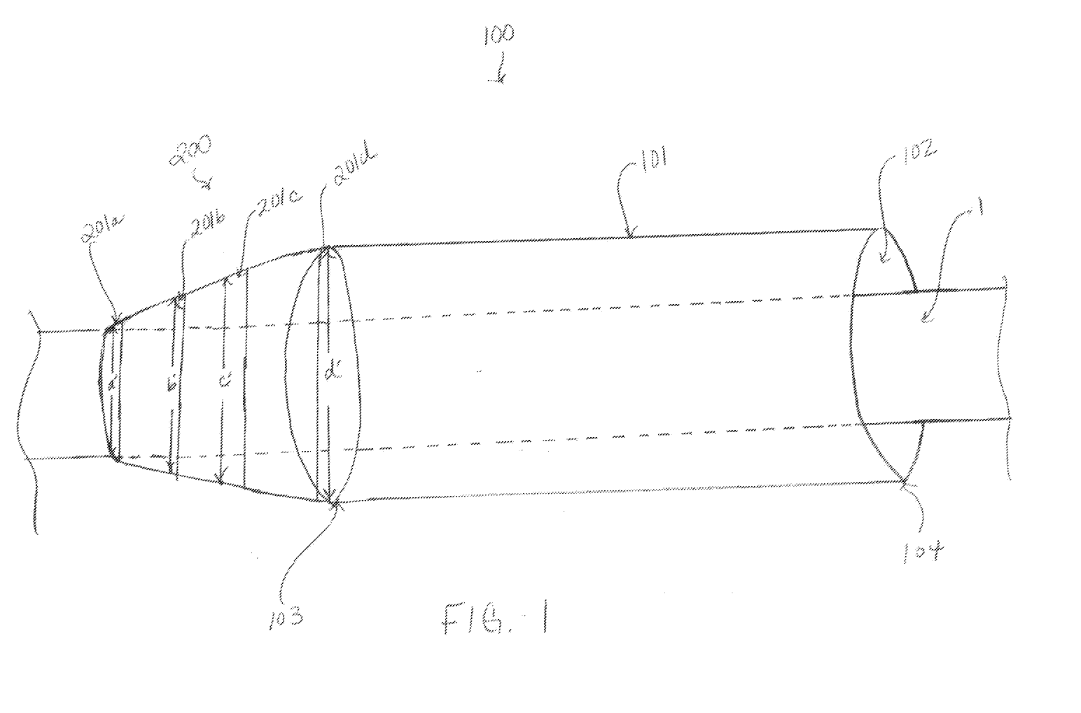

With reference now to FIG. 1, a pipe sleeve 100 is provided. As shown in FIG. 1, the pipe sleeve 100 is used for housing a portion of a pipe 1 (e.g., a service pipe). According to an embodiment of the present invention, the pipe sleeve 100 may be used for suitable purposes such as any structural building walls, foundations, residential houses, apartments, condos, bridges, or anywhere a service pipe is needed to be protected and properly sealed. The service pipe may be a plumbing pipe, electrical pipe, HVAC pipe or any other type of service pipe. The pipe sleeve 100 includes a body portion 101 which is formed of a sleeve-forming material in a tubular configuration such as polyvinyl chloride (PVC) pipe material. The body portion 101 may be formed of any suitable sleeve-forming material suitable for the purpose set forth herein. According to one embodiment of the present invention, the body portion 101 may be formed of a same material as that of the pipe 1.

According to an embodiment of the present invention, the body portion 101 includes a hollow interior 102 and a first end portion 103 and a second end portion 104 for receiving and housing the portion of the pipe 1 therein. A diameter of the body portion 101 may be of approximately 1½ inches to 20 inches for example. The diameter of the body portion 101 may be two sizes larger than that of the pipe 1 penetrating through the pipe sleeve 100, for example, however the present invention is not limited hereto and may vary accordingly. That is, the pipe sleeve 100 may be of any diameter, length or size to meet building international and domestic, and plumbing codes.

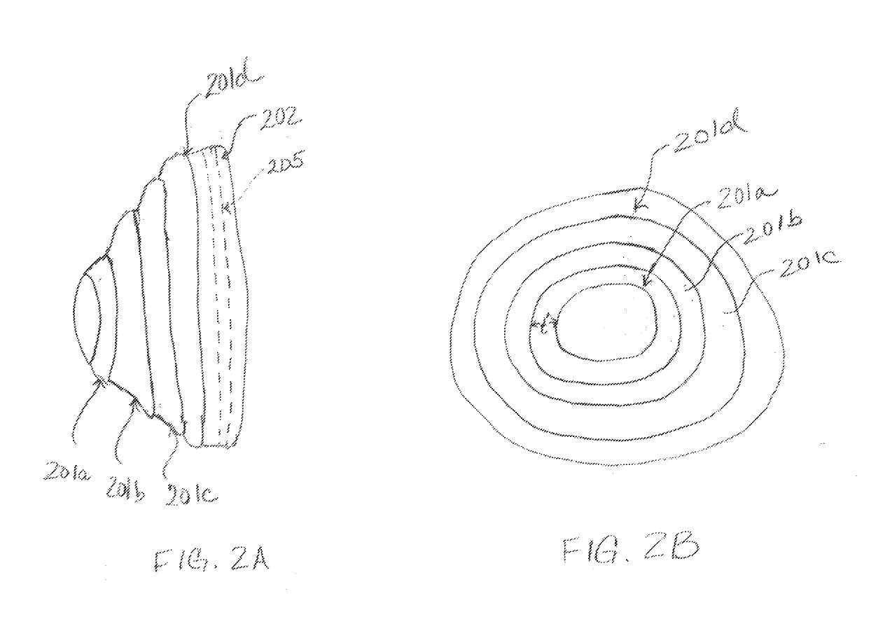

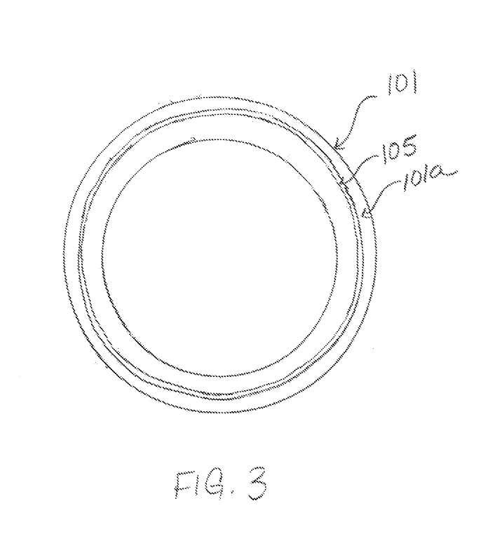

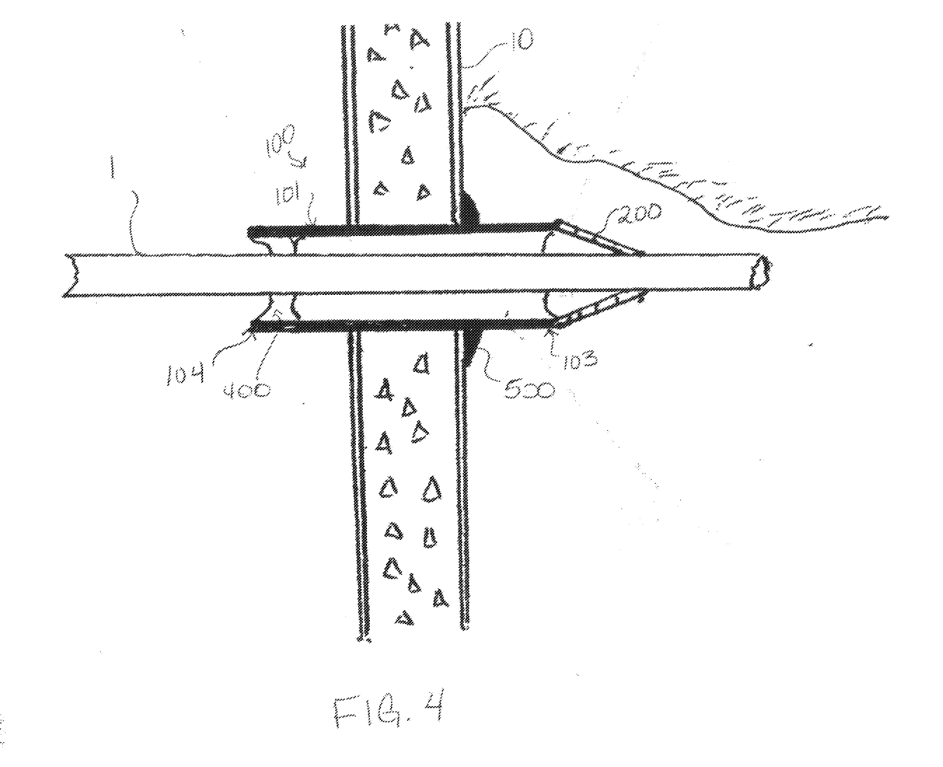

As further shown in FIG. 1 and FIG. 2, the pipe sleeve 100 also includes a flexible gasket portion (i.e., a boot) 200 formed at the first end 103 of the body portion 101 opposite the second end 104 which receives the portion of the pipe 1. According to an embodiment of the present invention, the flexible gasket portion 200 extends in an inner surface 101a of the body portion 101 (as shown in FIG. 3) at the first end 103 thereof a predetermined distance and conforms (i.e., molds) to a size of the portion of the pipe 1 and applies pressure thereto. According to one embodiment of the present invention, the flexible gasket portion 200 may be formed of a rubber material or a silicon material, for example, to conform to the size of the portion of the pipe 1 inserted therethrough. The present invention is not limited to the flexible gasket portion 200 being formed of a particular material and may be of any flexible material suitable for the purpose set forth herein. The flexible gasket portion 200 gives the ability and flexibility to extend the pipe sleeve 100 and seal the penetrating the pipe 1 (e.g., drain pipe) or other pipes. In addition, it prevents rodents, rats, ground water, rain water and other hazards that would potentially damage the pipe 1 or structure (e.g., a wall structure 10 shown in FIG. 4). Details regarding combining of the flexible gasket portion 200 with the body portion 101 will be discussed below with reference to FIGS. 2A and 3.

According to an embodiment of the present invention, the flexible gasket portion 200 is formed in a step-wise manner as shown in FIG. 1 such that a width (i.e., thickness) thereof decreases in size in a direction away from the first end 103 of the body portion 101. As shown in FIG. 2A, the flexible gasket portion 200 includes a plurality of boot portions 201 (i.e., 201a, 201b, 201c and 201d) integrally combined to form a single component, to accommodate varying sizes in pipes to be installed for construction purposes. The size of each boot portion 201 decreasingly varies in a direction away from the first end 103 of the body portion 101. For example, according to an embodiment of the present invention, the boot portion 201 a may have a width a′ of approximately 3 inches, the boot portion 201b may have a width b′ of approximately 4 inches, the boot portion 201c may have a width c′ of approximately 5 inches and the boot portion 201d may have a width d′ of approximately 6 inches. Further, as shown in FIG. 2B, the boot portions 201 may be each formed of a predetermined thickness t′ such as ½ inch. The predetermined length of each boot portion 201 may be the same or different from each other. The present invention is not limited to the body portion 101 or the flexible gasket portion 200 or boot portions 201 of the flexible gasket portion 200 being of a particular width or length and therefore may vary as needed. For example, the body portion 101 may be of a length of approximately 6 inches to 24 inches while the flexible gasket portion 200 may be of a length of approximately 6 inches. These boot portions 201 may be formed via a molding process during manufacturing thereof. Referring back to FIG. 2A, the flexible gasket portion 200 further includes an extended portion 202 which extends inside the body portion 101 by a predetermined distance such that when combined together, the body portion 101 and the flexible gasket portion 200 are aligned along a same plane. Details regarding the combination of the body portion 101 and the flexible gasket portion 200 will now be discussed below with reference to FIG. 2A and FIG. 3.

According to an embodiment of the present invention, the flexible gasket portion 200 may be combined with the body portion 101 by a melting or threading process, for example, or any other suitable combining means. As shown in FIG. 3, the body portion 101 may include a groove portion 105 within an inner surface 101a of the body portion 101 itself, to receive the extended portion 202 of the flexible gasket portion 200. The extended portion 202 may extend within the body portion 202 a predetermined distance such as approximately less than 2 inches, for example, however the present invention is not limited hereto and may vary accordingly. The extended portion 202 of the flexible gasket portion 200 may be inserted into the groove portion 105 and melted therein to create a connection between the body portion 101 and the flexible gasket portion 200. Alternatively, the extended portion 202 may include threads 205 (as shown in FIG. 2A) to be combined with threads (not shown) formed within the groove portion 105 of the body portion 101, to thereby combined the flexible gasket portion 200 with the body portion 101.

According to an embodiment of the present invention, the flexible gasket portion 200 may be inserted into the hollow interior 102 of the body portion 101 and remain there during installation of the pipe sleeve 100, and released from the hollow interior 102 upon insertion of the pipe 1.

According to another embodiment of the present invention, as shown in FIG. 4, a circular ring 400 made of rubber material for example, may be inserted at the second end 104 of the body portion 101 to fill the annular spaces between the pipe 1 and the pipe sleeve 100 to thereby provide extra protection to the pipe 1 penetrating the pipe sleeve 100. The combination of the pipe sleeve 100 and the circular ring 400 protects the pipes from stress and strain that exceeds the structural strength of the pipe due to expansion, contraction, and any structural settlement.

According to yet another embodiment of the present invention, as further shown in FIG. 4, a metal collar 500 may also be provided to be disposed around an exterior surface of the body portion 101 against a structure 10 (e.g., a wall structure, floors, or ceilings) through which the pipe sleeve 100 is inserted, to cover annular spaces created by a passage of the pipe sleeve 100 when penetrating through the structure 10. Thus, the metal collar 500 provides additional protection against possible damage created by rodents or water, for example.

According to other embodiments of the present invention, in addition to serving as protection to a pipe servicing plumbing, electrical, HVAC, gas and any other pipes penetrating walls (e.g., concrete walls), flooring, ceilings and etc., the pipe sleeve 100 may be used as plumbing testing equipment for drain waste and vent (“DWV”) and for servicing as a DWV pipe or emergency pipe for use when an existing pipe is broken. The pipe sleeve 100 is capable of solving the problem of a broken pipe based upon the implementation of the flexible gasket portion 200 attached to the body portion 101 of the pipe sleeve 100. Since the body portion 101 is made of PVC material, the pipe sleeve 100 may be used to catch the broken pipe and the flexible gasket portion 200 may be used to properly sleeve and seal the broken pipe. In this case, the body portion 101 may be cut to a desired length suitable for sealing the broken pipe. If used for plumbing testing equipment, since the pipe sleeve 100 includes the body portion 101 made of PVC pipe material, for example, and the flexible gasket portion 200, it is permitted to be used under ground and above ground in the plumbing industry for example, and in new industrial, commercial and residential buildings where plumbing DWV pipe is required to lay underground and the pipe exits the ground above concrete. The flexible gasket portion 200 may be used as a plug or cap for testing purposes, and at a later stage, the flexible gasket portion 200 may be cut and separated from the body portion 101 and the body portion 101 may serve as a plumbing DWV pipe. This technique may be applied to main drain testing where a service main drain exists a building, for example.

The pipe sleeve of the present invention provides the advantage of being able to accommodate pipes of various sizes which decreases costs associated with providing pipe sleeves for plumbing systems, and also provides an air-tight and water-proof seal between the pipe without the need for an additional sealant or sealing ring, and protects the pipe from the environment and vice versa. The use of the pipe sleeve also saves a lot of time, labor and associated expenses.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A pipe sleeve for housing a portion of a pipe and comprising:
a body portion having a hollow interior and first and second end portions for receiving and housing the portion of the pipe therein; and
a flexible gasket portion formed at the first end of the body portion opposite the second end receiving the portion of the pipe, wherein the flexible gasket portion extends into the hollow interior of the body portion at the first end thereof a predetermined distance, and conforms to a size of the portion of the pipe and applies pressure thereto.

2. The pipe sleeve of claim 1, wherein the body portion is formed of polyvinyl chloride (PVC).

3. The pipe sleeve of claim 2, wherein the flexible gasket portion is formed of a rubber or silicon material.

4. The pipe sleeve of claim 3, wherein the flexible gasket portion is formed in a step-wise manner to correspond to a size of the portion of the pipe to be housed in the pipe sleeve.

5. The pipe sleeve of claim 4, wherein the flexible gasket portion comprises:
a plurality of boot portions wherein each boot portion is integrally combined to one another and a width of each portion decreasingly varies in a direction away from the first end of the body portion; and
an extended portion which extends into an inner surface of the body portion at the first end thereof and is combined with the body portion therein.

6. The pipe sleeve of claim 5, wherein the predetermined distance is of approximately less than 2 inches.

7. The pipe sleeve of claim 5, wherein the body portion includes groove portions to receive the extended portion of the flexible gasket portion therein.

8. The pipe sleeve of claim 7, wherein the extended portion of the flexible gasket portion is combined with the body portion via a melting process in the groove portion of the body portion.

9. The pipe sleeve of claim 7, wherein the extended portion includes threads to be combined with the body portion via a threading process.

10. The pipe sleeve of claim 5, wherein the boot portions are of a same thickness.

11. The pipe sleeve of claim 1, further comprising:
a circular ring to be inserted at the second end of the body portion to fill annular spaces between the pipe and the pipe sleeve to support the pipe inserted therein.

12. The pipe sleeve of claim 1, further comprising:
a metal collar to be disposed around an exterior surface of the body portion against a structure through which the pipe sleeve is inserted, to cover annular spaces created by a passage of the pipe sleeve when penetrating through the structure.
